(19) United States
(12) Patent Application Publication
(10) Pub. No.: US 2011/0296292 A1
(43) Pub. Date: Dec. 1, 2011

(54) EFFICIENT APPLICATION-NEUTRAL VECTOR DOCUMENTS

(75) Inventors: Raman Narayanan, Seattle, WA (US); Rajendra Vishnumurty, Bellevue, WA (US); Ming Liu, Redmond, WA (US)

(73) Assignee: Microsoft Corporation, Redmond, WA (US)

(21) Appl. No.: 12/786,768

(22) Filed: May 25, 2010

(51) Int. Cl. G06F 17/00

(52) U.S. Cl. 715/234

(57) ABSTRACT

One or more techniques and/or systems are disclosed for generating application-neutral vector documents that provide for improved performance. A first glyph run for rendering a first portion of an application-neutral vector document is received, and assigned to a first set, based on its rendering characteristics. A second glyph run for rendering a second portion of the application-neutral vector document is received, and assigned to the first set if its rendering characteristics are compatible with the first glyph run's rendering characteristics; otherwise, it is assigned to a second set. Respective glyph runs are combined for respective sets into one or more combined glyph runs by combining strings to be rendered from the glyphs runs into a combined string, where the strings are combined in a sequence corresponding to an intended rendering. The application-neutral vector document, comprising the one or more combined glyph runs, is then generated.

### BACKGROUND

Application-neutral vector documents comprise rich document-formatting language that provides for saving application content in a format that allows end users to see the document on a display as they may see it when it is printed. This type of document may be referred to as a fixed document (FD) (e.g., portable document format (PDF), XML Paper Specification (XPS), JNT, MDI) which provides for a consistent document viewing experience on a wide range of operating systems, computer configurations, and printers.

An application-neutral document or FD can represent two-dimensional documents in a way that is independent of an application, hardware, or a particular operating system. An application-neutral document comprises a complete description of a fixed, two-dimensional layout of a document that can include text, fonts, images, and graphics. Application-neutral documents are often created by print drivers, such as when a word processor document is converted to a PDF-type file instead of physically printing.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Application-neutral vector documents or fixed documents (FDs) are typically comprised of tokens and interpreted results of a source code, to identify items in the page description and page appearance. For example, text in an application-neutral vector document can be expressed in glyph runs, such as written in an extensible application markup language (XAML). These glyph runs describe how the text is to be displayed, and can comprise a paragraph of information for a single character. Often, a single sentence can be expressed by dozens of glyph runs that take up pages of code.

As an example, a glyph run can be comprised of: a name of font, font size, font style, and set of characters it is rendering. If there are different styles, they have to be in different glyph runs; so whenever font changes, a new glyph run is needed. Some pages of application-neutral documents can be comprise of over eight-hundred glyph runs, for example, which can be multiplied by the number of pages to illustrate how much markup language, for example, may go into making one document.

One or more techniques and/or systems are disclosed herein for creating efficient application-neutral documents from an application or converted from another application-neutral document, for example. If text has a same style, font, color etc., a new glyph run may not be needed if characters are in a same Y position (e.g., same line), for example. That is, for example, if text has a same font for a set of consecutive glyph runs, and they start at same “y” location, separate glyph runs may not be needed and they can thus be combined.

In one embodiment of generating application-neutral vector documents that provide for improved performance, a first glyph run used for rendering a first portion of an application-neutral vector document is received, and assigned to a first set, based on the it's rendering characteristics. A second glyph run for rendering a second portion of the application-neutral vector document is received, and it is assigned to the first set if its rendering characteristics are compatible with the first glyph run's rendering characteristics; otherwise, the second glyph run is assigned to a second set. The respective glyph runs are combined for respective sets into one or more combined glyph runs. The combining comprises combining strings that are to be rendered from the glyphs runs into a combined string, where the strings are combined in a sequence corresponding to an intended rendering. The application-neutral vector document, comprising the one or more combined glyph runs, is generated.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for generating application-neutral vector documents that provide for improved performance.

FIG. 2A is an illustration of an exemplary embodiment of glyph runs used to render text in an application-neutral vector document.

FIG. 2 B is an illustration of an exemplary embodiment of a combined glyph used to render text in an application-neutral vector document.

FIG. 3 is a flow diagram illustrating an exemplary embodiment where a method for generating application-neutral vector documents that provide for improved performance may be implemented.

FIG. 4 is a component diagram of an example system for generating application-neutral vector documents that provide for improved performance.

FIG. 5 is a component diagram illustrating one embodiment where a system for generating application-neutral vector documents that provide for improved performance may be implemented.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

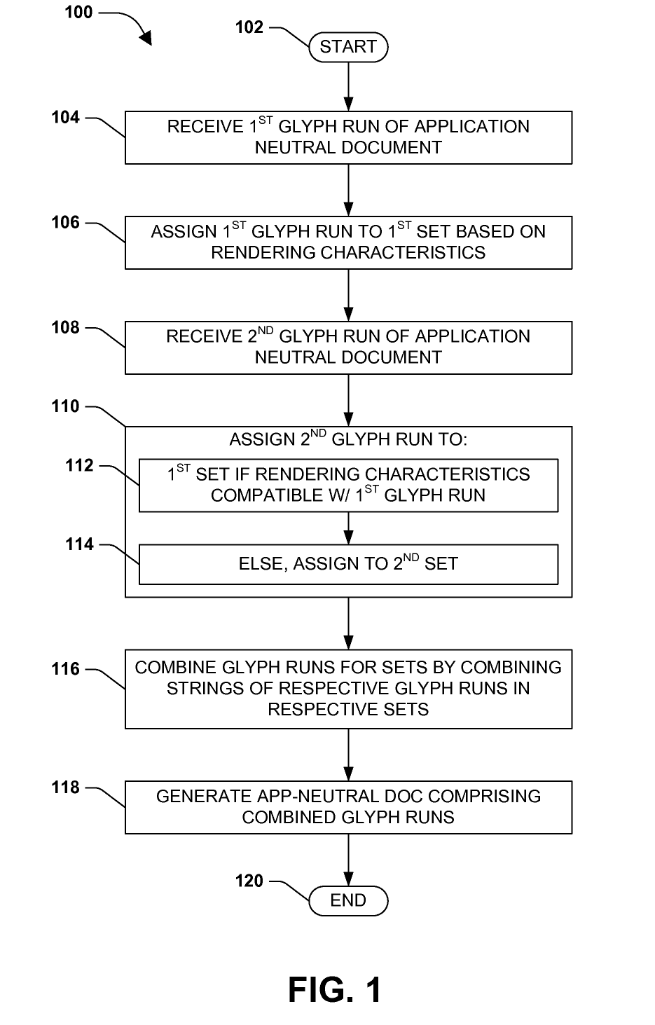

FIG. 1 is a flow diagram of an exemplary method 100 for generating application-neutral vector documents that provide for improved performance. The exemplary method 100 begins at 102 and involves receiving a first glyph run for rendering a first portion of an application-neutral vector document, at 104. In one embodiment, a glyph run can be an object expressed in computer code, such as extensible application markup language (XAML), which comprises font details, positions, and Unicode code points, used to render text in an application-neutral vector document (e.g., a portable document format (PDF) document).

As an example, an open extensible markup language (XML) paper specification document, such as an XPS (XML paper specification) document, can be created by printing to a virtual XPS printer driver. In this example, portions of the document intended for printing are processed by the driver, such as respective glyph runs, and are rendered in the output XPS document. Further, respective portions can be received for processing, such as in order of appearance in the document.

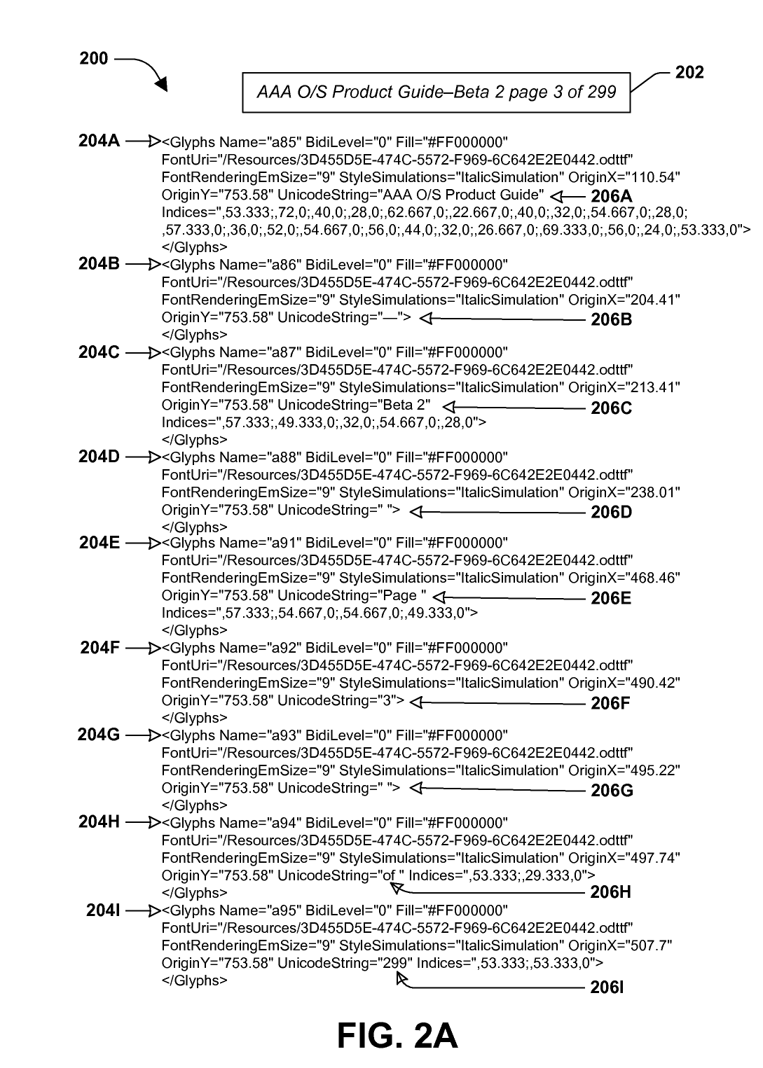

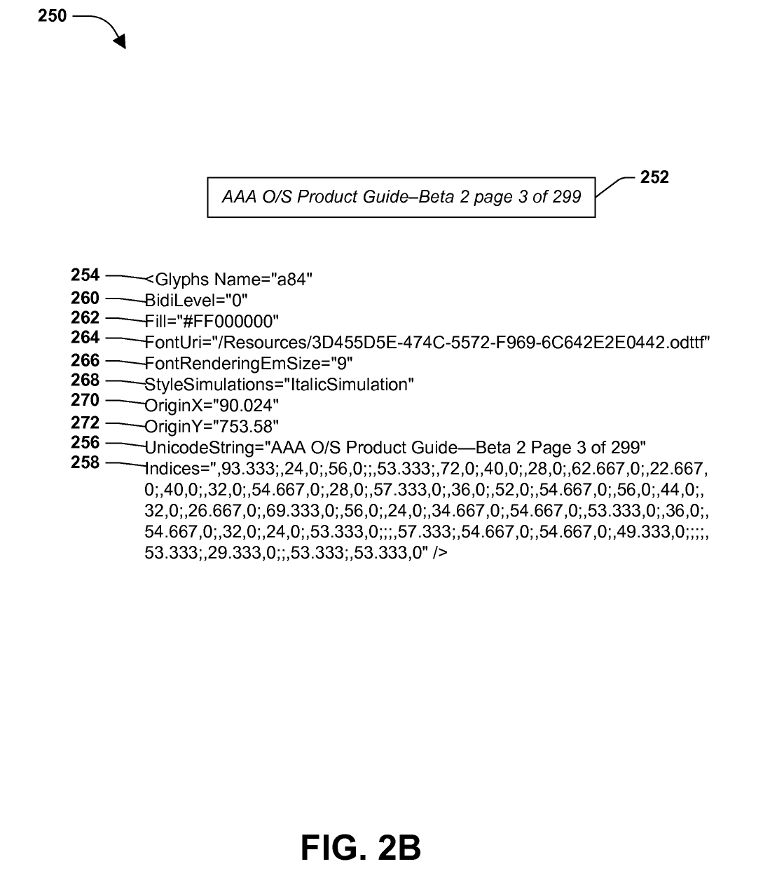

An example of a glyph run is illustrated in FIG. 2A, which is an illustration of an exemplary embodiment 200 of glyph runs used to render text in an application-neutral vector document. In this exemplary embodiment 200, a first glyph run 204A is a XAML object that can be used to render a portion of text 202 in the application-neutral vector document. In this example, the portion of text represented by the glyph is indicated by the Unicode string 206A “AAA O/S Product Guide.” Remaining elements of the glyph run 204A comprise font details and positions, which will be described in more detail below.

Returning to FIG. 1, at 106 of the exemplary method 100, the first glyph run is assigned to a first set based on the first glyph run's rendering characteristics. In one embodiment, the glyph run can be comprised of features that represent characteristics of how text may be rendered in the application-neutral vector document. For example, a glyph run can comprise a font resource identifier that specifies a resource for the font type, such as a file name, uniform resource identifier (URI), or resource reference in an application file. Further, the glyph run can comprise: a font size that specifies the font size (e.g., in drawing surface units); a font style that specifies special font flags (e.g., bold or italics); a fill color that specifies the color of the font; a bidirectional layout that specifies a direction for the string (e.g., right-left or left-right); and indices that can specify a layout for the text. In one embodiment, one or more of these features can be used to assign the first glyph run to a set, such as by Y axis origin, for example, which indicates how far down a page the text is rendered, for example.

As an example, in FIG. 2B, an example glyph run 250 comprises a plurality of features that express the rendering characteristics for text in an application-neutral vector document. In this example 250, the “BidiLevel” feature 260 indicates a bidirectional layout for the text, where “0” can default to rendering the text from left to right. The “Fill” feature 262 describes a color (e.g., black) for rendering the text. The “FontUri” feature 264 specifies a resource location for the font type, in this example, identifying an application file “3D455D5E-474C-5572-F969-6C642E2E0442.odttf” located in a “Resources” location (e.g., file folder).

Further, in this example, the “FontRenderingEmSize” feature 266 specifies a font size for rendering the text (e.g., 9 point). The “StyleSimulations” feature 268 indicates a special rendering flag for the text, in this case, “ItalicSimulation” (e.g., rendering the text in italics). The “OriginX” feature 270 specifies a location on the X axis of a page in the document where the text for this glyph is to begin when rendered (e.g., 90.024 pixels from the left). The “OriginY” feature 272 specifies a location on the Y axis of the page where the text for this glyph is to begin when rendered (e.g., 753.58 pixels from the top). The “UnicodeString” feature 256 indicates the text to be rendered, as described above. The “Indices” feature 258 specifies a layout for the text, such as a glyph index and certain placement and offset values for the text.

Returning to FIG. 1, at 108 of the exemplary method 100, a second glyph run is received for rendering a second portion of the application-neutral vector document. For example, a next portion of the document can be received for processing, such as by the virtual XPS printer driver. At 110, the second glyph run is assigned based on its rendering characteristics. If the second glyph run's rendering characteristics are compatible with the first glyph run's rendering characteristics, the second glyph run is assigned to the first set (e.g., comprising of the first glyph run), at 112. If the second glyph run's rendering characteristics are not compatible with the first glyph run's rendering characteristics, the second glyph run is assigned to a second set at 114.

In one embodiment, assigning a glyph run to a set based on the glyph run's rendering characteristics can comprise identifying the glyph run's Y axis origin, and assigning the glyph run to the set based on its Y axis origin. That is, for example, the first glyph run may comprise a first Y axis origin, and it is assigned to a first set that is identified by the first Y axis origin. In this example, if the second glyph run also comprises the first Y axis origin, it can be assigned to the first set. However, if the second glyph run comprises a second Y axis origin, it can be assigned to a second set identified by the second Y axis origin.

As an example, in FIG. 2A, glyph run 204A has an “OriginY” of “753.58.” In this example, glyph run 204A can be assigned to a set labeled as “OriginY=753.58.” Further, glyph run 204B has an “OriginY” of “753.58,” which is the same as glyph run 204A In this example, glyph run 204B can also be assigned to the set labeled “OriginY=753.58.” However, if glyph run 204B had a different “OriginY” value, such as “800”, it would be assigned to another set that is labeled “OriginY=800.” It will be appreciated that respective sets may be labeled or identified in alternate ways, such by an index, metadata, or some other characteristic, and the techniques and systems are not limited to the embodiments described herein.

Returning to FIG. 1, at 116 of the exemplary method 100, respective glyph runs for respective sets are combined into one or more combined glyph runs. Combining the glyph runs comprises combining strings (e.g., Unicode strings), which are intended to be rendered in the document, from the respective glyphs runs into a combined string. Respective strings are combined in a sequence that corresponds to an intended rendering in the document (e.g., in order of appearance in the application-neutral vector document).

As an example, as illustrated in FIGS. 2A and 2B, a plurality of glyph runs can be combined into a single combined glyph run. In the exemplary embodiment 200, the respective glyph runs 204A-204I are XAML expressions for rendering text 202 in an application-neutral vector document (e.g., XPS format document). The glyph runs 204A-204I respectively comprise a same “OriginY” value of “753.58.” Therefore, in one embodiment, the glyph runs 204A-204I can be assigned to a same set representing “OriginY=753.58,” for example.

Further, the glyph runs 204A-204I respectively comprise a “UnicodeString” feature value 206A-206I, for example, which can comprise some text (e.g., 206C), and/or symbols (e.g., 206B), and/or spaces (e.g., 206D). In one embodiment, the strings from the respective glyph runs from the same set are combined in order, by appending a second glyph run's string to a first glyph run's string. For example, the “UnicodeString” “-” 206B of glyph run 204B is appended to the “UnicodeString” “AAA O/S Product Guide” 206A of glyph run 204A, to get “AAA O/S Product Guide—” in 252 of FIG. 2B. Further, the respective glyph run strings 206C-206I can be appended to the combined glyph run string of 206A and 206B to get “AAA O/S Product Guide—Beta 2 page 3 of 299” at 252 of FIG. 2B. In this example, the combined glyph run 250 comprises a combined “UnicodeString” 256 that has the combined strings from the respective glyph runs 204A-204I.

Returning to FIG. 1, at 118 of the exemplary method 100, the application-neutral vector document comprising the one or more combined glyph runs is generated. That is, the document that provides rendering information can be generated, for example, where a plurality of glyph runs have been combined into a plurality of combined glyph runs. In this example, glyph runs that express text to be rendered on a same line can be combined, so that respective text lines in the document merely comprise one combined glyph run. In this way, the document is flattened to comprise less code (e.g., XAML).

Having generated the application-neutral vector document comprising the one or more combined glyph runs, the exemplary method 100 ends at 120.

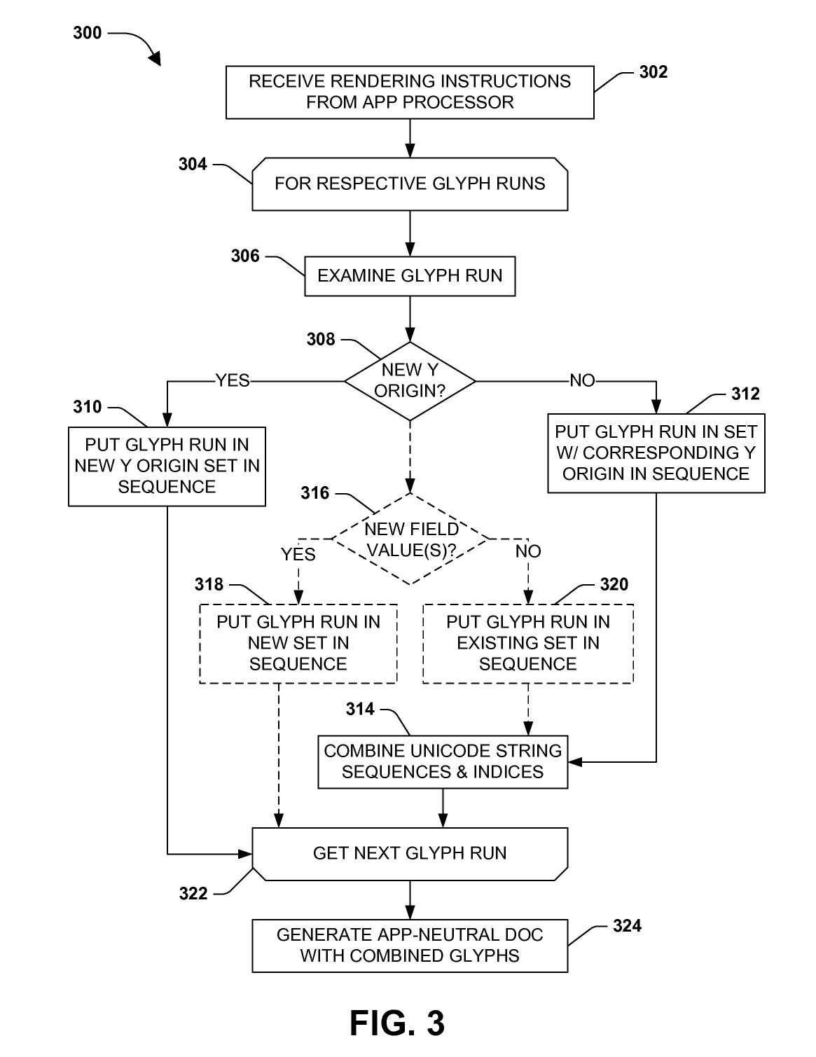

FIG. 3 is a flow diagram illustrating an exemplary embodiment 300 where a method for generating application-neutral vector documents that provide for improved performance may be implemented. At 302, document rendering instructions are received from a document processing application, such as a word processor, for example. In one embodiment, the rendering instructions can be used to generate the application-neutral vector document comprising one or more combined glyph runs. As an example, the word processor may send print rendering instructions, which can be used to create the combined glyph runs in an application-neutral document (e.g., XPS document).

For respective glyph runs, such as from the rendering instructions for the document, at 304, the glyph runs are examined, at 306. For example, as illustrated in FIG. 2B, the glyph runs can be comprised of several features. The glyph name 254, bidirectional level 260, fill color 262, font resource locator 264, font size 266, font style 268, X origin 270, Y origin 272, string 256, and indices 258 can be features examined, such as for determining in to which set to place the glyph run. At 308, the Y origin is examined to determine if it is new (e.g., has not been used for the document prior), or if there are other glyph runs that comprise the same Y origin.

At 310, if the glyph run comprises a new Y origin, such that the text run starts on a new line in the document, for example, the glyph run is put into a new set. In this embodiment, the glyph run can be put in the new set in sequence, such that it is a first glyph run in the set. Further, the set can be identified by the Y origin of the glyph run, for example. At 312, if the glyph run comprises a Y origin that has been identified in a previous glyph run (e.g., OriginY of FIG. 2A and FIG. 2B), the glyph run is put in the set that comprises the glyph runs having the same Y origin, in sequence. Therefore, for example, if the current glyph run under examination is the second glyph run having a same Y origin, it can be placed second in the set of the same Y origin.

At 314, for a set that comprise two or more glyph runs having a same Y origin, the Unicode strings and glyph indices can be combined in accordance with their sequence. As an example, in FIGS. 2A and 2B, the glyph runs 204A-204I comprise a same OriginY, and therefore can be put into a same set. Further, in this example, the UnicodeStrings 206A-206I can be combined, as shown in FIG. 2B at 256. Here, the Unicode strings have been combined in a sequence in which they appeared (e.g. or were sent for processing to be rendered). That is, a first string from a first glyph run is placed first in the sequence from the set, and a second string from a second glyph run is appended to the end of the first string, where the second glyph run is second in sequence in the set.

Further, in this embodiment, indices from a second glyph run are appended to indices from a first glyph run in sequence in which they appear, or are ordered in the set. As an example, the indices 258 of FIG. 2B comprise a combination of the indices from the glyph runs 204A-204I in FIG. 2A. Here, the indices are combined in the sequence in which they appear, or are sent for rendering, such as to a print driver. As described above, the indices comprise instructions that provide for spacing and placement of the respective text, for example. In one embodiment, the glyph fields from the first glyph run (e.g., 204A) can be combined with the combined string and combined indices to generate a combined glyph run (e.g., 250 of FIG. 2B).

Alternately, in FIG. 3, at 316, other glyph run fields can be examined to use for grouping glyph runs into sets. As described above, the glyph runs can comprise a plurality of features that may be used to distinguish glyph runs. In one embodiment, those glyph runs that comprise a same Y origin, font resource identifier, font size, fill color and layout direction may be grouped into a same set. In some embodiments, two or more features may be used to group glyph runs. In the exemplary embodiment 300, at 318, if a new field value is identified, such as a new font resource identifier, the glyph run can be placed into a new set. At 320, if new values are not identified for the fields that comprise an existing set, the glyph run can be grouped into the set comprising one or more glyph runs having the same values.

At 314, the glyph runs comprised in the sets can be combined, as described above. At 322 a next glyph run can be received, and examined at 306. The 304 to 322 sequence can continue until respective glyph runs are examined for the document. At 324, the application-neutral document can be generated, comprising the combined glyph runs. For example, the word processing application may send a document to the XPS print driver, and respective glyphs can be examined, grouped, combined, and an XPS document can be generated.

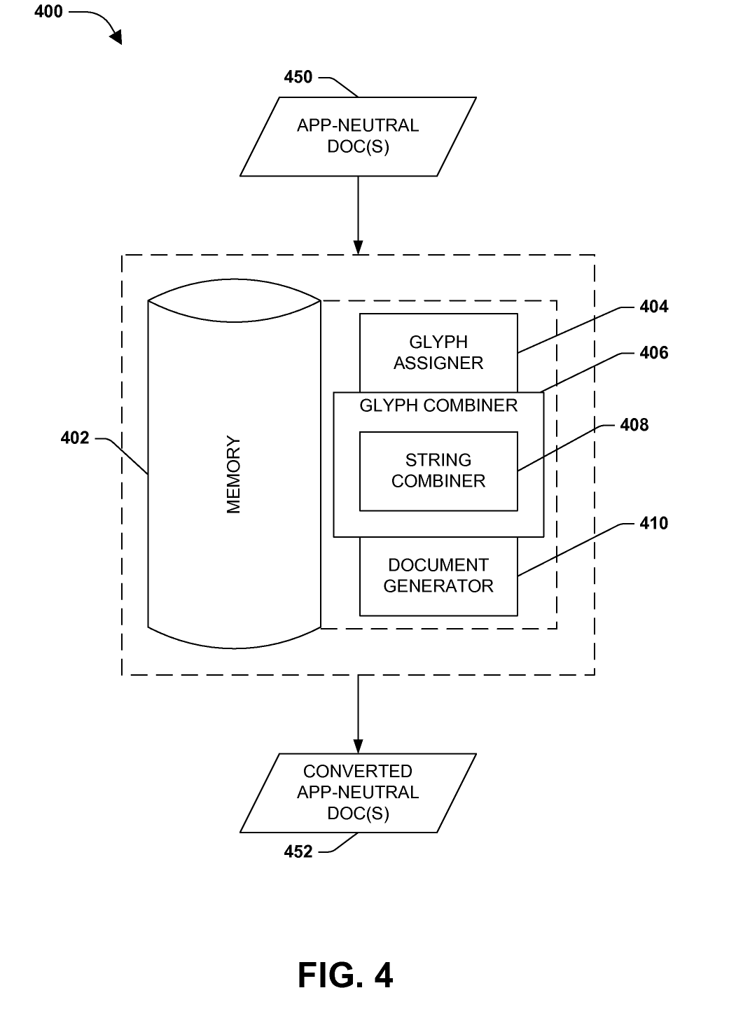

A system may be devised that provides for combining glyph runs to generate a flattened application-neutral document, for example. FIG. 4 is a component diagram of an example system 400 for generating application-neutral vector documents that provide for improved performance. A memory component 402 stores data for the system 400. A glyph assignment component 404 is operably coupled to the memory component 402, and is configured to receive glyph runs for portions of a document that are to be rendered. For example, the glyph assignment component 404 may retrieve or be sent glyph runs from the memory component 402 that come from an application-neutral document 450. Alternately, the glyph runs can originate from an application that has stored a document in memory, and the document is to be converted into an application-neutral document.

Glyph assignment component 404 assigns received glyph runs to a glyph set, stored in the memory component 402, where respective glyph runs in a set are compatible with each other for rendering purposes. That is, glyph runs that are assigned to a same set comprise one or more rendering features that have a same value (e.g., the same Y origin, font style, font size, etc.). In this way, for example, the memory component 402 may comprise one or more sets of glyph runs, where the set comprise glyph runs in sequence of potential rendering.

A glyph combining component 406 is operably coupled with memory component 402 and is configured to combine respective glyph runs for respective glyph sets into one or more combined glyph runs. The glyph combining component comprises a string combining component 408 that combines strings to be rendered from the respective glyphs runs into a combined string. The respective strings are combined in a sequence corresponding to an intended rendering, as described above. For example, text from a Unicode string is combined for the respective glyph runs in a set to produce a combined sequence of text in the order in which is to be rendered in the document (e.g., 450).

A document generation component 410 is operably coupled with the glyph combining component 406 to generate the application-neutral vector document 452 that comprise the one or more combined glyph runs, such as generated by the glyph combining component 406. Therefore, in one embodiment, an application-neutral document (e.g., PDF or XPS format) can be input to the exemplary system 400, and a flattened (e.g., comprising less rendering code) application-neutral document 452 can be generated.

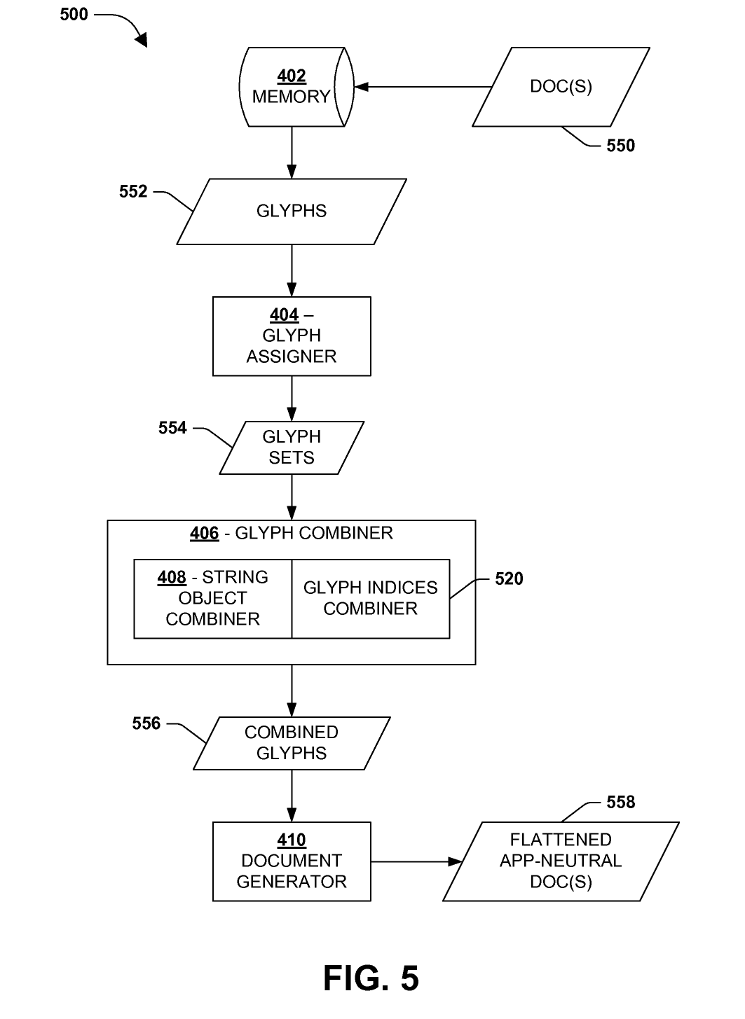

FIG. 5 is a component diagram illustrating one embodiment 500 where a system for generating application-neutral vector documents that provide for improved performance may be implemented. A document can be placed into the memory component 402, such as from a word processing application (or some other document generating application), intended for rendering in an application-neutral format. The glyph assigner can receive a first glyph run 552 for rendering a first portion of the application-neutral vector document 550 and assign the first glyph run to a first set 554, based on the first glyph run's rendering characteristics (e.g., Y origin).

The glyph assignment component 404 can examine one or more fields of a glyph run to identify glyph runs having one or more same field values. For example, a font size, style, resource identification, and others may be used to assign the glyph run to a set. In one embodiment, the glyph assignment component may merely use the Y origin to group the glyph runs. A second glyph run 552 can be received for rendering a second portion of the application-neutral vector document 550, and the second glyph run can be assigned to the first set 554 if the second glyph run's rendering characteristics are compatible with the first glyph run's rendering characteristics. Otherwise, in this embodiment, the second glyph run is assigned to a second set, such as stored in the memory component 402, based on the second glyph run's rendering characteristics.

In one embodiment, the glyph combining component 406 may merely combine two or more glyph runs from a set 554 where respective fields for Y axis origin, font-type, font-size, font-style, fill color, and bidirectional layout comprise a same property value for the respective glyph runs to be combined. That is, for example, the sets may be assigned based on a plurality of glyph run features, so that text is on a same line, and comprises the same type, size, and color of font, in order to be combined.

The string combining component 408 can combine one or more string objects from a first glyph run with one or more string objects from a second glyph run in accordance with a sequence of the glyph runs in the document, such as in order of assignment to a set 554. Further, the glyph combining component 406 can comprise a glyph indices combining component 520 that combines glyph indices from a first glyph run with glyph indices from a second glyph run in accordance with a sequence of the glyphs in the document.

In one embodiment, the glyph combining component 406 can use glyph field properties (e.g., font size, style, resource id, layout, etc.) from the first glyph run and combine them with combined Unicode string characters from the respective glyph runs in the set, and the combined indices for the respective glyph runs in the set, to generate a combined glyph run 556. As an example, the glyph run combining component 406 can combine the glyph runs in each set 554 generated by the glyph run assignment component 404, to generate a plurality of combined glyph runs 556 for the document generation component 410 to generate an application-neutral document 558 that is flattened to be more efficient.

In one embodiment, a document rendering instruction receiving component can be used to receive document rendering instructions from a document processing application (e.g., word processor), where the document rendering instructions comprise objects that represent respective non-combined glyphs for the document. For example, the word processor may send rendering instructions to a print driver that is configured to generate an XPS formatted document. The respective glyph runs can be received by the driver and sent to the exemplary system 500 for processing into flattened glyph runs, for example.

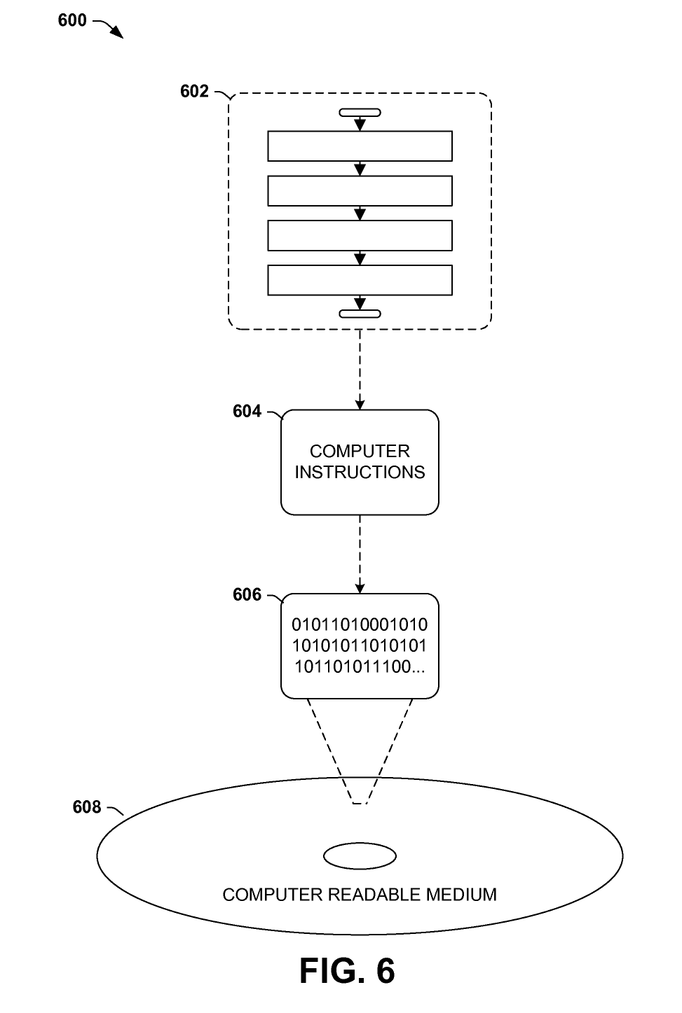

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as the exemplary method 100 of FIG. 1, for example. In another such embodiment, the processor-executable instructions 604 may be configured to implement a system, such as the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

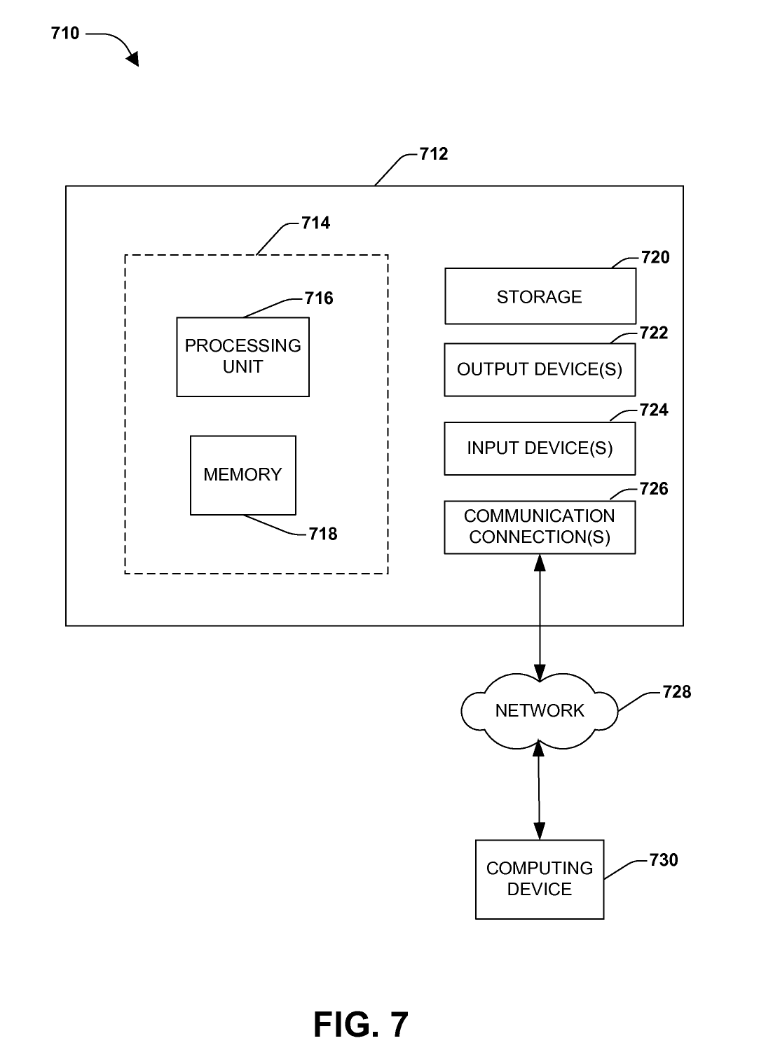

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for generating application-neutral vector documents that provide for improved performance, comprising:
receiving a first glyph run for rendering a first portion of an application-neutral vector document;
assigning the first glyph run to a first set, stored in memory of a computing device, based on the first glyph run's rendering characteristics;
receiving a second glyph run for rendering a second portion of the application-neutral vector document;
assigning the second glyph run to:
the first set if the second glyph run's rendering characteristics are compatible with the first glyph run's rendering characteristics; else
a second set, stored in memory of a computing device, based on the second glyph run's rendering characteristics;
combining respective glyph runs for respective sets into one or more combined glyph runs, comprising combining strings to be rendered from the respective glyphs runs into a combined string, where respective strings are combined in a sequence corresponding to an intended rendering, using a processor in the computing device; and
generating the application-neutral vector document comprising the one or more combined glyph runs.

2. The method of claim 1, comprising:
identifying the second glyph run's Y axis origin; and
assigning the second glyph run to the first set or the second set based on the identified Y axis origin.

3. The method of claim 1, comprising:
identifying one or more features for the second glyph run comprising at least one of:
font size;
font style;
fill color; and
bidirectional layout; and
assigning the second glyph run to the first set or the second set based on the identified one or more features.

4. The method of claim 1, combining respective glyph runs for respective sets into one or more combined glyph runs, comprising combining glyph indices from the respective glyph runs in accordance with the sequence of the glyph runs.

5. The method of claim 1, combining strings to be rendered from the respective glyphs runs into a combined string comprising combining a sequence of one or more Unicode string characters from a first glyph run with a sequence of one or more Unicode string characters from a second glyph run to generate a combined Unicode string of characters for the combined glyph run.

6. The method of claim 1, combining strings to be rendered from the respective glyphs runs into a combined string comprising appending a second string of one or more characters to a first string of one or more characters, where the first string is first in the sequence of the glyph runs from a same set.

7. The method of claim 1, generating the application-neutral vector document comprising the one or more combined glyph runs comprising generating an application-neutral vector document comprising XAMLformat expressions of the combined glyph runs.

8. The method of claim 1, comprising:
receiving document rendering instructions from a document processing application; and
using the rendering instructions to generate the application-neutral vector document comprising the one or more combined glyph runs.

9. The method of claim 1, combining respective glyph runs for respective sets comprising:
appending one or more string characters from the second glyph run to one or more string characters of the first glyph run, where the first glyph run is ordered before the second glyph run in sequence in a structure of the document, to generate the combined string;
appending one or more indices from the second glyph run to one or more indices of the first glyph run, to generate combined indices; and
using glyph fields from the first glyph run, combined with the combined string and combined indices, to generate a combined glyph run.

10. A system for generating application-neutral vector documents that provide for improved performance, comprising:
a memory component configured to store data for the system;
a glyph assignment component operably coupled to the memory component, and configured to:
receive glyph runs for rendering portions of an application neutral document; and
assign received glyph runs to a glyph set, stored in the memory component, where respective glyph runs in a set are compatible with each other for rendering purposes;
a glyph combining component operably coupled with memory component and configured to combine respective glyph runs for respective glyph sets into one or more combined glyph runs, the glyph combining component comprising a string combining component configured to combine strings to be rendered from the respective glyphs runs into a combined string, where respective strings are combined in a sequence corresponding to an intended rendering; and
a document generation component operably coupled with the glyph combining component, and configured to generate the application-neutral vector document comprising the one or more combined glyph runs.

11. The system of claim 10, the glyph assignment component configured to:
receive a first glyph run for rendering a first portion of an application-neutral vector document;
assign the first glyph run to a first set, stored in the memory component, based on the first glyph run's rendering characteristics;
receive a second glyph run for rendering a second portion of the application-neutral vector document; and
assign the second glyph run to:
the first set if the second glyph run's rendering characteristics are compatible with the first glyph run's rendering characteristics; else
a second set, stored in memory of a computing device, based on the second glyph run's rendering characteristics.

12. The system of claim 10, the glyph assignment component configured to examine one or more fields of a glyph run to identify glyph runs having one or more same field values.

13. The system of claim 12, the glyph assignment component configured to identify those glyph runs comprising a same Y axis origin field.

14. The system of claim 10, the glyph combining component configured to merely combine two or more glyph runs where respective fields for Y axis origin, font-type, font-size, font-style, fill color, and bidirectional layout comprise a same property value for the respective glyph runs to be combined.

15. The system of claim 10, the string combining component configured to combine one or more string objects from a first glyph run with one or more string objects from a second glyph run in accordance with a sequence of the glyph runs in the document.

16. The system of claim 10, the glyph combining component comprising a glyph indices combining component configured to combine glyph indices from a first glyph run with glyph indices from a second glyph run in accordance with a sequence of the glyphs in the document.

17. The system of claim 10, the string objects comprising Unicode string characters.

18. The system of claim 10, comprising a document rendering instruction receiving component configured to receive document rendering instructions from a document processing application, the document rendering instructions comprising objects that represent respective non-combined glyphs for the document.

19. The system of claim 10, the glyph combining component configured to use glyph field properties from the first glyph run, combined with the combined string characters and combined indices, to generate a combined glyph run.

20. A computer-based method for generating application-neutral vector documents that provide for improved performance, comprising:
identifying one or more sets of glyph runs in a first application-neutral vector document, stored in memory of a computing device, a set of glyph runs comprising glyph runs that comprise a same Y axis origin;
combining two or more glyph runs from a set to generate a combined glyph run, comprising:
combining a sequence of one or more Unicode string characters from a first glyph run with a sequence of one or more Unicode string characters from a second glyph run to generate a combined Unicode string of characters for the combined glyph run;
appending one or more indices from the second glyph run to one or more indices of the first glyph run, to generate combined indices; and
using glyph fields from the first glyph run, combined with the combined string of characters and combined indices, to generate the combined glyph run; and
generating a second application-neutral vector document comprising the combined glyph run.
